(19) United States
(12) Patent Application Publication
(10) Pub. No.: US 2010/0072347 A1
(43) Pub. Date: Mar. 25, 2010

(54) SHUTTERING FOR CONTAINERS

(75) Inventor: Johann Wolf, Scharnstein (AT)

Correspondence Address: YOUNG & THOMPSON, 209 Madison Street, Suite 500, Alexandria, VA, 22314, US

(73) Assignee: WOLF MODUL GMBH, Scharnstein (AT)

(21) Appl. No.: 12/525,490

(22) PCT Filed: Feb. 18, 2008
(86) PCT No.: PCT/AT2008/000052

§ 371 Date: Jul. 31, 2009

(30) Foreign Application Priority Data
Feb. 22, 2007 (AT) A 282/2007

(51) Int. Cl. B28B 7/36; E04G 11/20

(52) U.S. Cl. 249/27; 249/99; 249/134; 249/98

(57) ABSTRACT

Shuttering for containers, particularly for round containers, comprises lining elements (10) detachably fastened to the shuttering elements, the lining elements having anchoring elements (12) protruding from the shuttering elements (5) on the side facing away from the same, so that after filling and curing the concrete the lining elements (10) remain adhered to the (concrete) wall (17) after the shuttering elements (5) have been removed. After removing the shuttering, a container (16) having a lining, particularly an interior lining, is obtained, wherein it suffices to tightly seal the joints (14) between adjacent lining elements (10), for example, using a joint filling agent (18).

The invention relates to a formwork for receptacles, especially round receptacles such as silos.

Formwork for round receptacles is known in various embodiments, in which connection reference can be made to AT 322 191 B as an example.

Depending on the material to be loaded into the receptacle, it is necessary to provide the receptacle with an inside lining to prevent the generally concrete receptacle from being attacked and damaged by aggressive media.

The application of (inside) linings, regardless of whether they consist of rubber, ceramic, plastic or metal, is a tedious and complex matter since in the receptacle, a scaffold must be erected on which the workers stand while they are applying the inside lining, on the one hand, and since provision must be made for sufficient ventilation of the receptacle interior so that the workers do not suffer from lack of air, on the other hand.

The object of the invention is to propose formwork for receptacles, especially round receptacles, with which the application of linings, especially outside and/or inside linings of receptacles, especially round receptacles such as silos, is simplified.

This object is achieved according to the invention with formwork that has the features of claim 1.

Preferred and advantageous embodiments of the invention are the subject matter of the dependent claims.

Since in the formwork according to the invention, a lining element is fastened to formwork elements (for example as sheeting) in a manner that is detachable from the latter, the lining is applied directly when the receptacle (made of concrete) is produced. After the production of the receptacle (made of concrete) or prefabricated elements (made of concrete) that are then joined to form a receptacle, the formwork is removed, the connection between the formwork element, on the one hand, and the lining element, on the other hand, being released at the same time or having been released beforehand. The lining element then remains on the receptacle, especially on the inside of round receptacles.

In this way, lining elements made of any materials, such as duroplastics (polyesters), thermoplastics, rubber-elastic plastics or natural rubber or else of metal or ceramic, can be attached to the wall of the receptacle inside and/or outside.

In order to ensure a secure seat of the lining element on the wall of the receptacle, especially on the inside and/or the outside of a receptacle wall, projecting from the side of the lining element facing away from the formwork element, there can be projections, such as nubs, fibers, hair or else screw-like pegs and the like that ensure retention. When screws, screwed inserts or the like are used as anchoring elements for the lining elements, the lining elements if necessary (repair) can be easily removed from the wall of the receptacle and can be replaced by a (new) lining element.

After the receptacle or the prefabricated element for the receptacle is completed, the joints between adjacent lining elements are closed by, for example, a cement being applied for duroplastics, welding being done for thermoplastics, vulcanization being done for rubber-elastic materials or the lining elements being soldered or welded to one another for metals.

The invention can likewise be used for (round) receptacles such as silos that are poured monolithically from concrete, as well as on receptacles that are assembled from individual segments (prefabricated concrete parts).

It is preferable, however, if the invention is used in the production of monolithically poured concrete receptacles as they can be produced, for example, using the round formwork known from AT 322 191 B, in order to produce an inside lining (lining of the inner surface of the receptacle wall) and/or an outside lining (lining of the outer surface of the receptacle). The invention is not limited to round receptacles, however. For (round) receptacles, an inside lining and/or an outside lining can be produced with the invention.

Advantageously within the framework of the invention, it is provided in one preferred embodiment that the lining elements have the shape and size of the formwork elements to which they are (temporarily) attached.

With respect to the fact that in all lining elements and especially in lining elements of metal or of rubber-elastic material, such as elastomer plastics or natural rubber, there is the danger that the lining elements can be damaged and/or concrete bordering the lining elements can be destroyed and replacement of lining elements of metal or rubber-elastic materials can be complex, lining elements of duroplastics, especially of polyester, are preferred within the framework of the invention. When using lining elements of fiber-reinforced polyester or the like, upgrades are easily possible, as is also the replacement of individual lining elements. The latter is also because sealing of the joints between adjacent lining elements is especially simple for duroplastic lining elements, especially when it is polyester or the like. In this connection, for sealing of joints between lining elements, (glass) fiber-reinforced synthetic resin (polyesters) can also be used.

Other details and features of the invention will become apparent from the following description based on one preferred embodiment of the formwork according to the invention, as is shown in the drawings.

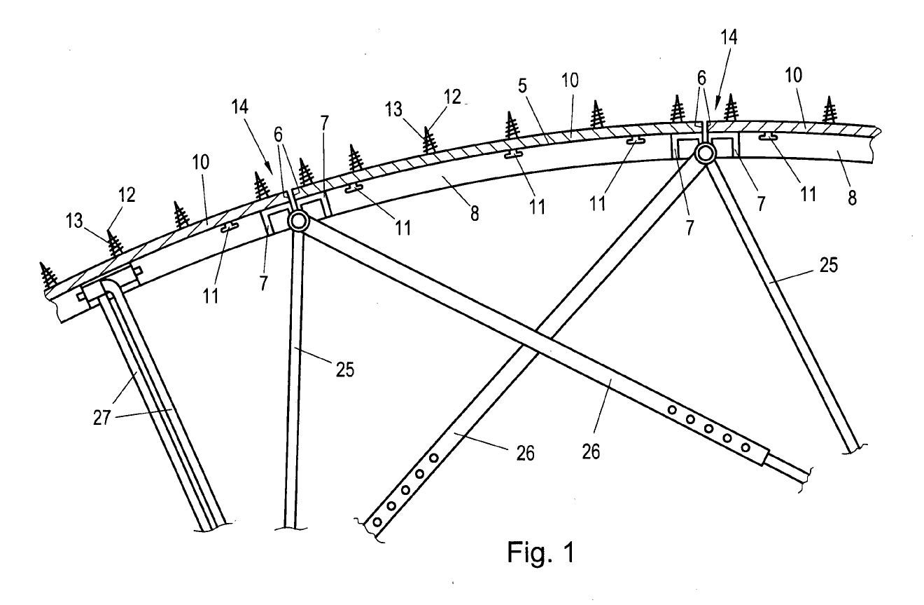

FIG. 1 shows formwork in a horizontal section,

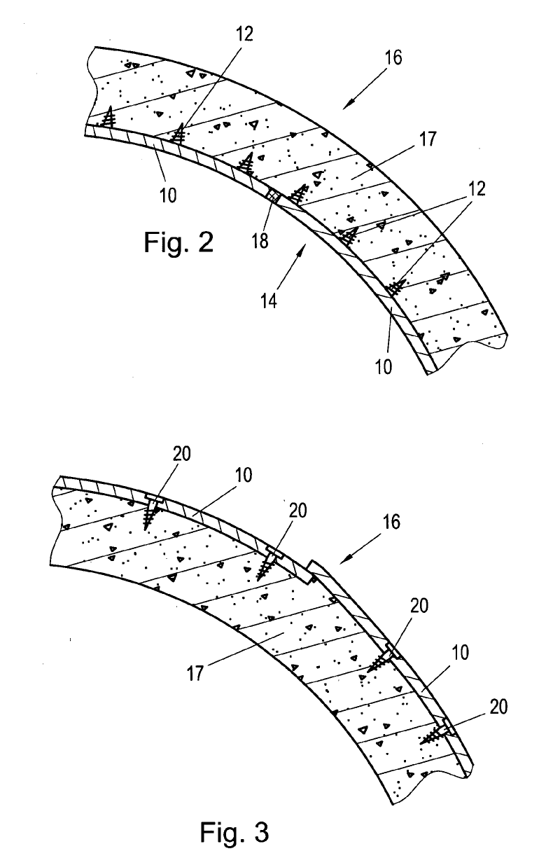

FIG. 2 shows a round receptacle in a horizontal section (partially), and

FIG. 3 shows round receptacles with outside lining partially in horizontal sections.

The inside formwork shown partially in FIG. 1 in the production of monolithically poured concrete round silos has formwork elements (sheeting) 5 that are supported on, for example, vertical members (not shown) arranged in a circle and that have edge bracing 7, 8. Support takes place by means of horizontal braces 25 that are routed between formwork elements 5 and opposing vertical members. Other braces 26 that are variable in length and that are arranged horizontally lead to formwork elements 5 adjacent to outside contact edges 6 and are detachably connected there to the angle profiles 7 in the same manner as the braces 25. The braces 25 and 26 are detachably connected to the vertical members in order to allow removal of the inside formwork. Here, the braces 26 of variable length cross one another and proceed from adjacent vertical members located in the middle, by which reliable support arises. In addition, there can be braces 27 that are detachably connected to the stiffening angles 26 of the formwork elements 5, which cross one another, which lie in one radial plane and which are arranged obliquely to the vertical.

According to this invention, on the convex outside surface of each formwork element 5, one lining element 10 at a time is temporarily, i.e., detachably, attached. The attachment can be formed by, for example, pegs 11 that extend through holes provided in the convex surfaces of the formwork elements 5. The button-like pegs 11 are snapped, for example, in the manner of snap fasteners into the holes in the formwork elements 5 and are preferably dimensioned in their stems such that the heads of the pegs 11 tear off when the formwork elements 5 are removed when the formwork is dismantled. Thus, the lining elements 10 remain adhering to the (concrete) wall 17 of the receptacle 16.

The lining elements 10 can be attached to the formwork elements 5 also using screws or the like.

In addition, the surface of the lining elements 10 facing the concrete to be placed for producing the receptacle (silo) is made with a good “grip” in order to ensure reliable anchoring of the lining element 10 in the concrete of the wall of the receptacle. This gripping configuration can be achieved by nub-like projections, by hairs, by projecting bristles, by peg-like projections 12 that are made, for example, with ribs 13 (similarly to screws) that run transversely to their lengthwise extension or the like.

It is critical that the lining elements 5 after placing and setting of the concrete are reliably fixed to it, so that after removing the inside formwork, they remain reliably adhering to the inside surface of the wall 17 of the concrete receptacle 16. Secure retention of lining elements 10 on the wall 17 of a receptacle 16 can also be achieved by screw anchors 20 (FIG. 3). Screw anchors 20 advantageously allow replacement of the lining elements 10.

It is now sufficient to close only the joints 14 between adjacent lining elements 10; for metal lining elements, this can be done by welding or soldering or by permanent elastic or curing joint filling masses, for elements of thermoplastic by welding or fusing, for elements of rubber or elastomer plastics by vulcanization, and for elements of duroplastic (polyester) by a cement, for example polyester cementing.

In a horizontal section, FIG. 2 shows an extract of the (concrete) wall 17 of a round receptacle 16. On the inside of the wall 17, there are lining elements 10 that are held by pegs 12 in the concrete. The vertical (and horizontal) joints 14 between adjacent lining elements 10 are closed, in particular sealed, by a filling mass 18, for example a cement. The pegs 12 can also be screws (screwed inserts or screw anchors).

It is apparent that receptacles 16 can be made of concrete on site with the formwork according to the invention, therefore formwork with (detachable) lining elements 10 attached temporarily to the formwork elements 5, the receptacles 16 being directly provided with a lining that is formed by the lining elements 10.

The invention is equally advantageous for receptacles that are produced from prefabricated elements when formwork according to the invention is used for producing the elements at least on one side.

The formwork elements 5 that bear the lining elements 10 according to the invention need not necessarily be equipped with sheeting. In principle, formwork elements in the form of frames to which the lining elements 10 are (temporarily) fixed are sufficient.

When lining elements 10 are attached to receptacles (round silos) as outside linings with the formwork according to the invention, it is considered that adjacent lining elements 10 overlap one another in their edge regions.

In summary, one exemplary embodiment of the invention can be described as follows:

Formwork for receptacles, especially round receptacles, has lining elements 10 that are detachably fastened to formwork elements 5 with anchoring elements 12 that project on their side facing away from the formwork element 5 from the latter so that after the placing and setting of the concrete, the lining elements 10 remain adhering to the (concrete) wall 17 after the formwork elements 5 have been removed. After the formwork is dismantled, a receptacle 16 is obtained with a lining, especially an inside lining, its being sufficient to tightly seal the joints 14 between adjacent lining elements 10, for example with a joint filling mass 18.

1. Formwork for receptacles with formwork elements (5), characterized in that lining elements (10) for the receptacle (16) to be produced are detachably fastened to formwork elements (5).

2. Formwork according to claim 1, wherein the formwork is round formwork.

3. Formwork according to claim 1, wherein the lining elements (10) are located on an inside formwork and/or an outside formwork for formwork elements (5) that form (round) formwork.

4. Formwork according to claim 2, wherein the lining elements (10) are located on a convexly or a concavely arched surface of formwork elements (5).

5. Formwork according to claim 1, wherein the lining elements (10) are fixed on formwork elements (5) by projections (11) that fit into holes in the formwork elements (5).

6. Formwork according to claim 1, wherein the projections (11) are button-like pegs that fit in the manner of snap fasteners into holes of the formwork elements (5).

7. Formwork according to claim 5, wherein the projections (11) that fix the lining elements (10) on the formwork elements (5) are made separable.

8. Formwork according to claim 1, wherein the lining elements (10) are screwed onto the formwork elements (5).

9. Formwork according to claim 8, wherein the screws extend through holes in the lining elements (10).

10. Formwork according to claim 1, wherein the lining elements (10) on their side facing away from the formwork element (5) are provided with projections (12) that fit into the wall of the receptacle to be produced.

11. Formwork according to claim 10, wherein the projections are hairs.

12. Formwork according to claim 10, wherein the projections are nubs.

13. Formwork according to claim 10, wherein the projections are optionally ribbed pegs (12, 13), especially screwed inserts or screw anchors (20).

14. Formwork according to claim 10, wherein the projections are bristles.

15. Formwork according to claim 1, wherein the lining elements (10) consist of a plastic.

16. Formwork according to claim 15, wherein the lining elements (10) consist of a thermoplastic.

17. Formwork according to claim 15, wherein the lining elements (10) consist of a duroplastic.

18. Formwork according to claim 15, wherein the lining elements (10) consist of polyester.

19. Formwork according to claim 15, wherein the lining elements (10) consist of an elastomer (rubber-elastic) material, especially an elastomer plastic.

20. Formwork according to claim 1, wherein the lining elements (10) consist of metal or ceramic.

21. Formwork according to claim 20, wherein the lining elements (10) are metal sheets.

22. Formwork according to claim 1, wherein the lining elements (10) are located on the outside surface of inside formwork (5) and/or on the inside surface of outside formwork for monolithically poured (concrete) receptacles.

23. Formwork according to claim 1, wherein the lining elements (10) are located on formwork elements (5) for prefabricated elements for receptacles.

24. Formwork according to claim 1, wherein the lining element (10) has the shape and dimensions of the formwork element (5) to which it is attached.

25. Receptacle (16) produced using formwork according to claim 1, wherein the joints (14) between the adjacent lining elements (10) are closed, especially by a filling mass (18).

26. Receptacle produced according to claim 25, wherein the joints (14) are welded or soldered.

27. Receptacle according to claim 25, wherein the holes in the lining elements (10) are closed, especially sealed, welded or soldered.

28. Receptacle produced according to claim 25, wherein the joints (14) are cemented.

29. Receptacle according to claim 25, wherein the lining elements (10) are located on the inside and/or the outside of the wall (17) of a round receptacle (16).

30. Receptacle according to claim 25, wherein there are lining slabs (10) that are adjacent to one another and that are provided on the outside overlapping one another on vertical and/or horizontal edges.
